(19) United States
(12) Patent Application Publication
(10) Pub. No.: US 2024/0204813 A1
(43) Pub. Date: Jun. 20, 2024

(54) APPARATUS, SYSTEM, AND METHOD FOR DYNAMICALLY TUNING RADIOS BASED ON DETECTABLE USE-CASE SCENARIOS

(71) Applicant: Meta Platforms Technologies, LLC, Menlo Park, CA (US)

(72) Inventors: Nivethitha Jayaraj, San Jose, CA (US); Weiping Dou, Cupertino, CA (US); Ping Wang, Redmond, WA (US); Jiang Zhu, Cupertino, CA (US); Achaleshwar Sahai, San Jose, CA (US); Joung Sub Shin, Irvine, CA (US); De Hui Huang, Pleasanton, CA (US); Jibu Joseph, Santa Clara, CA (US); Jie Song, Fremont, CA (US)

(21) Appl. No.: 18/065,985

(22) Filed: Dec. 14, 2022

(51) Int. Cl. H04B 1/16; H04B 17/318

(52) U.S. Cl. CPC H04B 1/16; H04B 17/318

(57) ABSTRACT

A system comprising (1) a tuner configured to tune a radio and (2) a controller communicatively coupled to the tuner, wherein the controller is configured to (1) select a tuner code to apply to the tuner based at least in part on telemetry data indicative of a certain use-case scenario and (2) cause the tuner to tune the radio by applying the tuner code to achieve a certain state of the radio. Various other apparatuses, devices, systems, and methods are also disclosed.

### BRIEF DESCRIPTION OF DRAWINGS

The accompanying drawings illustrate a number of exemplary embodiments and are parts of the specification. Together with the following description, the drawings demonstrate and explain various principles of the instant disclosure.

FIG. 1 is a block diagram of an exemplary radio that facilitates and/or supports dynamic tuning based on detectable use-case scenarios according to one or more embodiments of this disclosure.

FIG. 2 is a block diagram of an exemplary system that facilitates and/or supports dynamically tuning radios based on detectable use-case scenarios according to one or more embodiments of this disclosure.

FIG. 3 is a block diagram of an exemplary system that facilitates and/or supports dynamically tuning radios based on detectable use-case scenarios according to one or more embodiments of this disclosure.

FIG. 4 is a block diagram of an exemplary implementation involving a communication link between a computing device and a system that facilitates and/or supports dynamically tuning radios based on detectable use-case scenarios according to one or more embodiments of this disclosure.

FIG. 5 is an illustration of an exemplary use-case scenario for which a radio is dynamically tuned according to one or more embodiments of this disclosure.

FIG. 6 is an illustration of an exemplary use-case scenario for which a radio is dynamically tuned according to one or more embodiments of this disclosure.

FIG. 7 is a flowchart of an exemplary method for dynamically tuning radios based on detectable use-case scenarios according to one or more embodiments of this disclosure.

FIG. 8 is an illustration of exemplary augmented-reality system that may be used in connection with embodiments of this disclosure.

FIG. 9 is an illustration of an exemplary virtual-reality system that may be used in connection with embodiments of this disclosure.

FIG. 10 is an illustration of exemplary haptic devices that may be used in connection with embodiments of this disclosure.

FIG. 11 is an illustration of an exemplary virtual-reality environment according to embodiments of this disclosure.

FIG. 12 is an illustration of an exemplary augmented-reality environment according to embodiments of this disclosure.

While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, combinations, equivalents, and alternatives falling within this disclosure.

### DETAILED DESCRIPTION

The present disclosure is generally directed to apparatuses, systems, and methods for dynamically tuning radios based on detectable use-case scenarios. As will be explained in greater detail below, these apparatuses, systems, and methods may provide numerous features and benefits.

For example, the apparatuses, systems, and methods described herein may improve Adaptive Open Loop (AOL) tuning of radios by sweeping different tuner states (e.g., states of aperture tuners and impedance tuners). Such sweeping may make AOL tuning of radios more robust and/or reliable for different use-case scenarios. Additionally or alternatively, these apparatuses, systems, and methods may also compensate and/or account for different use-case scenarios when tuning the radios. Examples of such use-case scenarios include, without limitation, being worn on a user's wrist, being held between a user's fingers, being placed on a table, variations or combinations of one or more of the same, and/or any other suitable use-case scenarios.

In some examples, AOL tuning may be triggered by an event. For example, a device (e.g., a smartwatch) may detect an event (e.g., a user action, a position change, and/or an environment change) and then optimize antenna tuning based at least in part on the event. In one example, the event may include and/or represent the detection of certain sensor data and/or modem or link performance indicators.

In some examples, the apparatuses, systems, and methods described herein may use, rely on, and/or apply offline analyses to identify which tuning states function best for each use-case scenario and then store those tuning states in lookup tables. In such examples, when a subsequent event occurs, these apparatuses, systems, and methods may search and/or check the lookup table for the best tuning state and then select the recommended tuning state. Additionally or alternatively, these apparatuses, systems, and methods may perform live calculations based at least in part on current modem or link performance indicators. In one example, these live calculations may indicate and/or show whether another tuning state might be better suited for the current use-case scenario. If a live calculation indicates and/or shows that another tuning state is likely better suited, these apparatuses, systems, and methods may select that other tuning state instead. In this way, the apparatuses, systems, and methods may continuously and/or adaptively tune their antennas to ensure optimum efficiency in each use-case scenario.

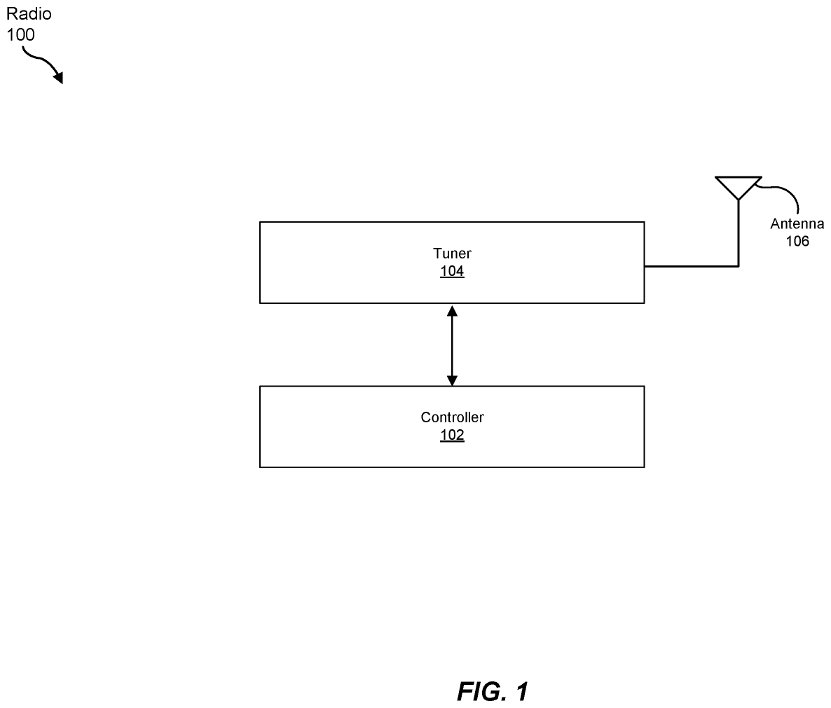

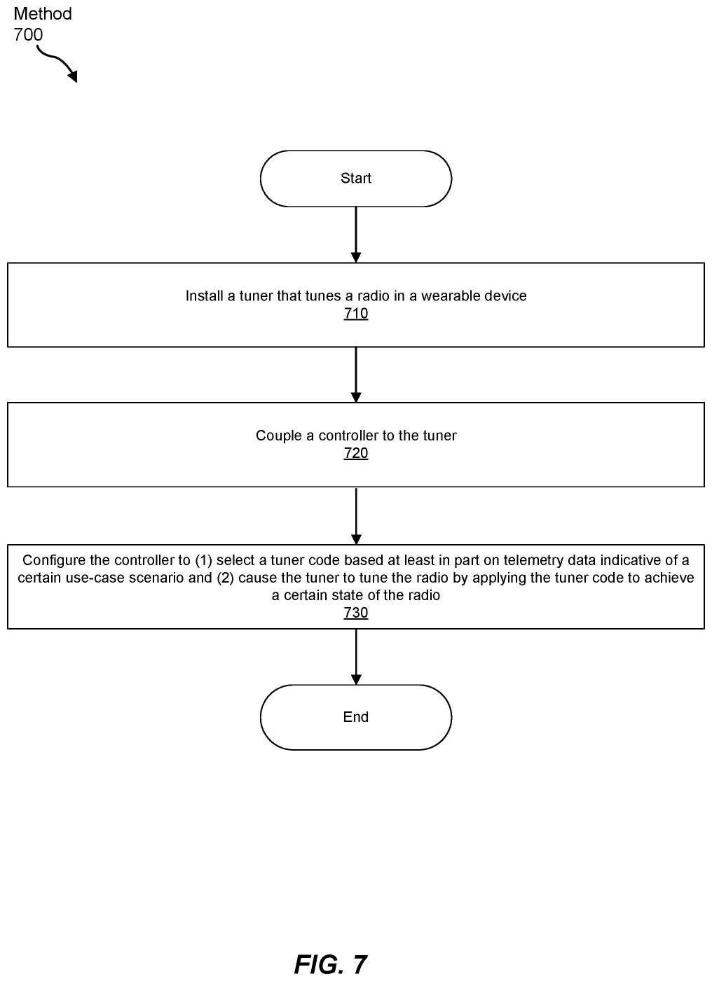

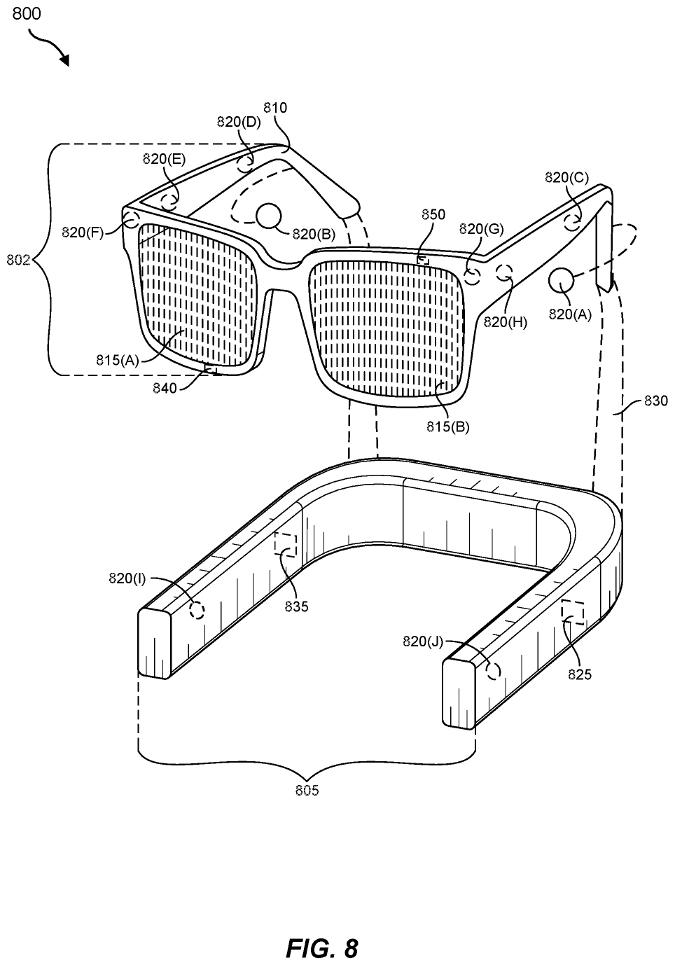

The following will provide, with reference to FIGS. 1-6, detailed descriptions of exemplary devices, systems, components, and corresponding implementations for dynamically tuning radios based on detectable use-case scenarios. In addition, detailed descriptions of methods for dynamically tuning radios based on detectable use-case scenarios will be provided in connection with FIG. 7. The discussion corresponding to FIGS. 8-12 will provide detailed descriptions of types of exemplary artificial-reality devices, wearables, and/or associated systems capable of dynamically tuning radios based on detectable use-case scenarios.

FIG. 1 illustrates a portion of an exemplary radio 100 capable of being dynamically tuned based at least in part on detectable use-case scenarios. In some examples, radio 100 may be integrated and/or incorporated into a wearable device (not necessarily illustrated in FIG. 1). As illustrated in FIG. 1, exemplary radio 100 may include and/or represent a controller 102, a tuner 104, and/or an antenna 106. In some examples, controller 102 and tuner 104 may be communicatively coupled to one another. Additionally or alternatively, tuner 104 and antenna 106 may be communicatively coupled to one another.

In some examples, tuner 104 may tune and/or program radio 100. In one example, controller 102 may select and/or choose a tuner code to apply to tuner 104 based at least in part on telemetry data indicative of a certain use-case scenario. Additionally or alternatively, controller 102 may cause tuner 104 to tune and/or program radio 100 by applying the tuner code to achieve a certain state of radio 100.

In some examples, controller 102 may include and/or represent any type or form of hardware-implemented processing device and/or component capable of interpreting and/or executing computer-readable instructions. In one example, controller 102 may access, execute, and/or modify certain software modules to facilitate and/or support dynamically tuning radios based at least in part on detectable use-case scenarios. Examples of controller 102 include, without limitation, physical processors, Central Processing Units (CPUs), microprocessors, microcontrollers, Field-Programmable Gate Arrays (FPGAs) that implement softcore processors, Application-Specific Integrated Circuits (ASICs), Systems on a Chip (SoCs), integrated circuits, portions of one or more of the same, variations or combinations of one or more of the same, and/or any other suitable controller.

In some examples, tuner 104 may include and/or represent any type or form of hardware-implemented device and/or component capable of tuning radio 100 and/or antenna 106 to a specific frequency and/or range for reception and/or transmission. In such examples, tuner 104 may facilitate and/or support tuning antenna 106 to certain frequencies, thus enabling antenna 106 to transmit and/or receive communications via different frequencies. In one example, tuner 104 may include and/or represent an impedance tuner and/or an aperture tuner.

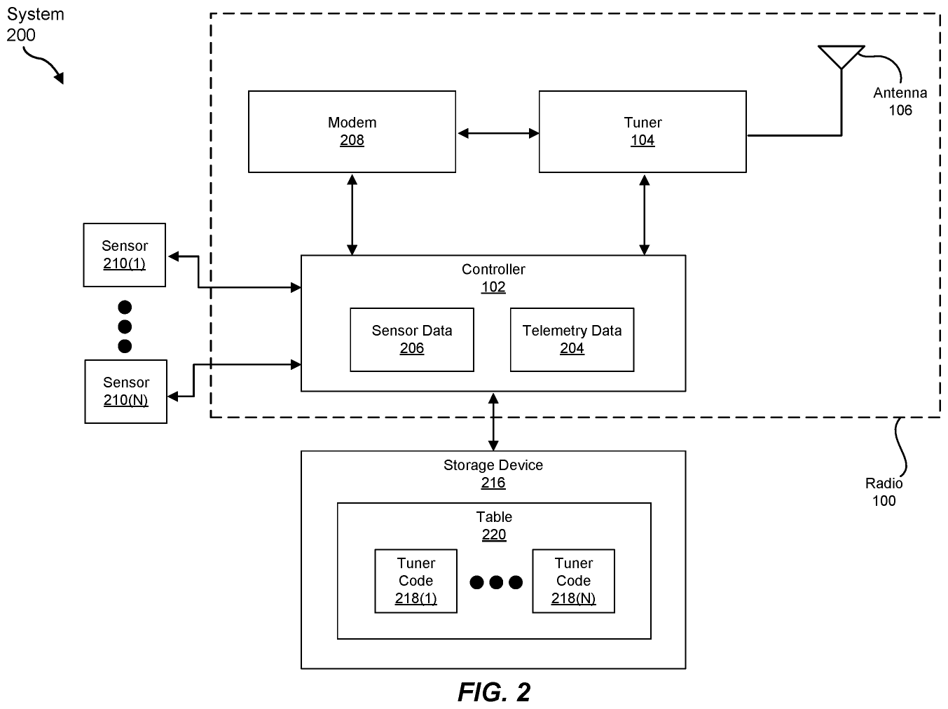

FIG. 2 illustrates a portion of an exemplary system 200 capable of dynamically turning radio 100 based at least in part on detectable use-case scenarios. In some examples, system 200 may include and/or represent certain components and/or features that perform and/or provide functionalities that are similar and/or identical to those described above in connection with FIG. 1. As illustrated in FIG. 2, exemplary system 200 may include and/or represent radio 100, a storage device 216, and/or sensors 210(1)-(N). In some examples, controller 102 and storage device 216 may be communicatively coupled to one another. Additionally or alternatively, controller 102 and sensors 210(1)-(N) may be communicatively coupled to one another.

In some examples, radio 100 may also include and/or represent a modem 208 that is communicatively coupled between controller 102 and tuner 104. In one example, modem 208 may generate, produce, and/or provide one or more measurements about a communication link involving radio 100 to controller 102. In this example, the communication link may include and/or represent a connection established and/or formed between radio 100 and a remote device. Radio 100 may send communications to and/or receive communications from the remote device via the communication link.

In some examples, the measurements provided by modem 208 may constitute and/or represent some or all of telemetry data 204 used by controller 102 to select the tuner code for application to tuner 104. In one example, these measurements may include and/or represent key performance indicators of the communication link. Examples of such measurements include, without limitation, Reference Signal Received Power (RSRP) measurements of the communication link, Reference Signal Received Quality (RSRQ) measurements of the communication link, Received Signal Strength Indicator (RSSI) measurements of the communication link, Signal-to-Noise Ratio (SNR) measurements of the communication link, combinations or variations of one or more of the same, and/or any other suitable measurements.

In some examples, controller 102 may cause and/or direct modem 208 to apply the tuner code to tuner 104. By applying the tuner code to tuner 104 in this way, modem 208 may cause tuner 104 to achieve a certain state of operation for radio 100. In one example, this state of operation may constitute and/or represent an improvement (e.g., increased gain and/or decibel levels) over the performance of radio 100 prior to the application of the tuner code.

In some examples, storage device 216 may store and/or maintain a table 220 of tuner codes 218(1)-(N) mapped to indexing and/or matching data. In such examples, tuner codes 218(1)-(N) may each correspond to and/or represent a certain frequency band within a set of frequency bands. For example, when applied to tuner 104, tuner code 218(1) may cause and/or direct tuner 104 to tune or program radio 100 and/or antenna 106 to a specific frequency band and/or channel. In this example, when applied to tuner 104, tuner code 218(N) may cause and/or direct tuner 104 to tune or program radio 100 and/or antenna 106 to a different frequency band and/or channel.

In some examples, the indexing and/or matching data embedded in table 220 may correspond to and/or represent various use-case scenarios. In one example, the use-case scenarios may constitute and/or represent uses, actions, and/or states of a device (e.g., a wearable device) that incorporates radio 100. Examples of such use-case scenarios include, without limitation, a device being worn on a user's wrist, a device being held in a user's fingers, a device being carried in a user's pocket, a device being oriented in a certain direction, a device being used with a certain accessory, a device being touched at a certain location by a user, a device being placed on a table or desk, a device moving from one place to another (e.g., by bicycle, walking, or running), a device undergoing a certain gesture by a user, combinations or variations of one or more of the same, and/or any other suitable use-case scenarios.

In some examples, the indexing and/or matching data may be assigned to the respective tuner codes included in table 220 based at least in part on offline analyses. For example, in a laboratory environment, analysts may determine that tuner code 218(1) appears to improve the performance of radio 100 for the majority of users operating radio 100 under a specific use-case scenario. In this example, the analysts may identify tuner code 218(1) as the best option for that specific use-case scenario and then designate tuner code 218(1) accordingly in table 220. In another example, in this laboratory environment, the analysts may determine that tuner code 218(N) appears to improve the performance of radio 100 for the majority of users operating radio 100 under a different use-case scenario. In this example, the analysts may identify tuner code 218(N) as the best option for that different use-case scenario and then designate tuner code 218(N) accordingly in table 220.

In some examples, sensors 210(1)-(N) may generate, create, and/or produce sensor data 206 about a state of a device (e.g., a wearable device) that incorporates radio 100. In such examples, sensors 210(1)-(N) may send, provide, and/or deliver sensor data 206 to controller 102. Examples of sensors 210(1)-(N) include, without limitation, touch sensors, vibration sensors, pressure sensors, accelerometers, gyroscopes, transducers, combinations or variations of one or more of the same, and/or any other suitable sensors.

In some examples, sensor data 206 may constitute and/or represent a portion or all of telemetry data 204 used by controller 102 to select the tuner code for application to tuner 104. Examples of sensor data 206 include, without limitation, touch-sensor data, vibration-sensor data, pressure-sensor data, accelerometer data, gyroscope data, transducer data, combinations or variations of one or more of the same, and/or any other suitable sensor data.

In some examples, controller 102 may receive, obtain, and/or retrieve sensor data 206 from sensors 210(1)-(N). In one example, controller 102 may apply and/or incorporate sensor data 206 into telemetry data 204. In this example, controller 102 may analyze, evaluate, and/or examine sensor data 206 and/or telemetry data 204 to identify and/or determine a certain use-case scenario of radio 100 and/or the underlying device that incorporates radio 100.

In some examples, controller 102 may search table 220 for any tuner code that corresponds to and/or represents that use-case scenario. In one example, controller 102 may perform and/or conduct the search with telemetry data 204. In this example, controller 102 may be able to identify and/or locate the appropriate tuner code for that use-case scenario during the search by matching telemetry data 204 with the indexing data corresponding to that use-case scenario. Additionally or alternatively, controller 102 may perform and/or conduct the search with a description and/or identifier corresponding to and/or representative of that use-case scenario. In this example, controller 102 may be able to identify and/or locate the appropriate tuner code for that use-case scenario during the search by identifying such a description and/or identifier in the indexing data corresponding to that use-case scenario.

In some examples, controller 102 may identify and/or locate a subset of candidate tuner codes stored in table 220 based at least in part on telemetry data 204. For example, controller 102 may search table 220 for a subset of candidate tuner codes (e.g., less than all of tuner codes 218(1)-(N)) based at least in part on telemetry data 204 representative of a certain use-case scenario. In one example, controller 102 may sweep across the subset of candidate tuner codes to test different states of radio 100 when each of the subset of candidate tuner codes are applied. In this example, modem 208 may measure certain key performance indicators (e.g., RSRP, RSRQ, RSSI, and/or SNR) of radio 100 and/or tuner 104 during the sweep across the subset of candidate tuner codes.

In some examples, controller 102 may receive, obtain, and/or retrieve these key performance indicators from modem 208. In one example, controller 102 may compare the key performance indicators of radio 100 and/or tuner 104 from before and after having swept through the subset of candidate tuner codes. In this example, if the performance of radio 100 and/or tuner 104 improves by a sufficient amount during the sweep, controller 102 may identify and/or determine which of the candidate tuner codes improves performance the most. In other words, controller 102 may identify and/or determine the tuner code that constitutes and/or represents the most optimal selection for tuner 104 under that use-case scenario. Controller 102 may then configure and/or program tuner 104 with the tuner code that leads to the most improvement in that use-case scenario.

In some examples, table 220 may be updated to include, account for, and/or prioritize certain tuner codes. For example, comparable radios may be implemented and/or deployed throughout a vast userbase. In this example, those radios may each detect certain use-case scenarios and then sweep across subsets of candidate tuner codes based at least in part on those use-case scenarios. Those radios may identify and/or determine the tuner codes that constitute and/or represent the most optimal selections under those use-case scenarios. Those radios may upload those optimal selections to a centralized device for distribution to radio 100 and/or controller 102. Additionally or alternatively, those radios may send and/or transmit those optimal selections to radio 100 and/or controller 102.

In some examples, controller 102 may receive, obtain, and/or retrieve the tuner codes that were found to be the most optimal for other radios under certain use-case scenarios. In such examples, controller 102 may update and/or modify table 220 to include, account for, and/or prioritize one or more of the tuner codes that improved the performance of those other radios. Accordingly, controller 102 may rely on and/or consume crowdsourced information used to populate table 220 with tuner codes preferred by the other radios under certain use-case scenarios.

In some examples, controller 102 may be able to select the appropriate tuner code without relying on a Voltage Standing Wave Ratio (VSWR) detector or considering a VSWR of radio 100. Accordingly, controller 102 may enable radio 100 to perform this type of tuner-code selection even though radio 100 is not equipped with a VSWR detector. In one example, controller 102 may identify and/or detect a certain use-case scenario based at least in part on telemetry data 204. In this example, controller 102 may identify a frequency band of radio 100 that corresponds to that use-case scenario. For example, controller 102 may search table 220 for information that identifies a frequency band that corresponds to that use-case scenario. Additionally or alternatively, controller 102 may select a tuner code (e.g., tuner code 218(1)) from table 220 to apply to tuner 104 based at least in part on the frequency band corresponding to that use-case scenario.

In some examples, table 220 may include and/or represent entries that render, indicate, and/or specify different tuner codes depending on the model of one or more components of radio 100. For example, table 220 may include and/or represent an entry corresponding to a certain use-case scenario. In this example, the entry may identify and/or specify one tuner code for models with a first radio component and another tuner code for models with a second radio component.

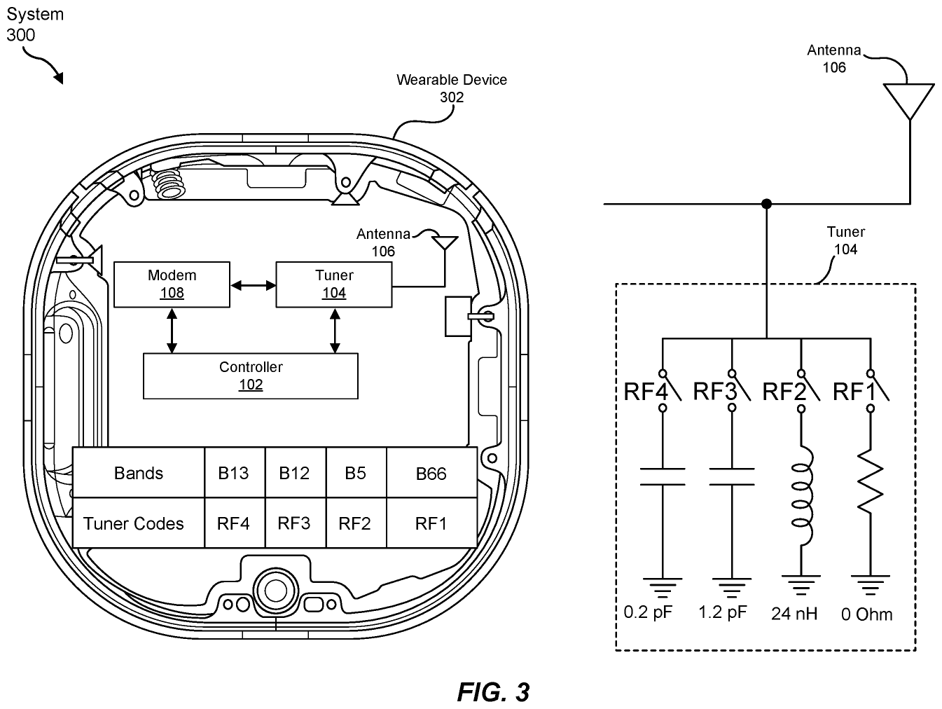

FIG. 3 illustrates a portion of an exemplary system 300 capable of dynamically turning radio 100 based at least in part on detectable use-case scenarios. In some examples, system 300 may include and/or represent certain components and/or features that perform and/or provide functionalities that are similar and/or identical to those described above in connection with FIG. 1 or FIG. 2. As illustrated in FIG. 3, exemplary system 300 may include and/or represent a wearable device 302 equipped with radio 100. In this example, radio 100 may include and/or represent controller 102, modem 108, tuner 104, and/or antenna 106.

In some examples, wearable device 302 may include and/or represent a smartwatch. Additional examples of wearable device 302 include, without limitation, wristbands, armbands, pendants, bracelets, rings, jewelry, ankle bands, clothing, electronic textiles, shoes, clips, headbands, gloves, variations or combinations of one or more of the same, and/or any other suitable wearable devices.

In some examples, tuner 104 may include and/or represent certain electrical components and/or features capable of being engaged and/or disengaged to achieve different tuning states. For example, tuner 104 may include and/or represent a programmable resonant circuit that implements a network of one or more capacitors, inductors, and/or resistors. In one example, the tuner code selected by controller 102 may cause and/or direct tuner 104 to apply one or more of those capacitors, inductors, and/or resistors via programmable switches to achieve a certain tuning state.

In one example, controller 102 may detect an event (e.g., a position change) that triggers a modification to tuner 104. For example, controller 102 may analyze telemetry data 204 as collected from sensors 210(1)-(N) on a smartwatch in response to a position change. In this example, controller 102 may determine that a user donning the smartwatch has performed a certain gesture based at least in part on telemetry data 204. As specific examples, controller 102 may determine that the user is donning the smartwatch on the user's wrist, that the user is holding the smartwatch with one or more fingers, that the user is touching the face of the smartwatch in a certain way, that the user is operating the smartwatch in free space (e.g., without a cradle), and/or that the user is operating the smartwatch with a certain accessory (e.g., with a cradle).

In one example, controller 102 may select a tuner code that corresponds to the detected gesture and/or use-case scenario of wearable device 302. In this example, controller 102 may cause and/or direct tuner 104 to apply the selected tuner code to achieve a certain tuning state for radio 100. In certain implementations, the newly applied tuner code may enable radio 100 to improve performance (e.g., increasing gain and/or decibel levels) of a communication link between wearable device 302 and a remote device.

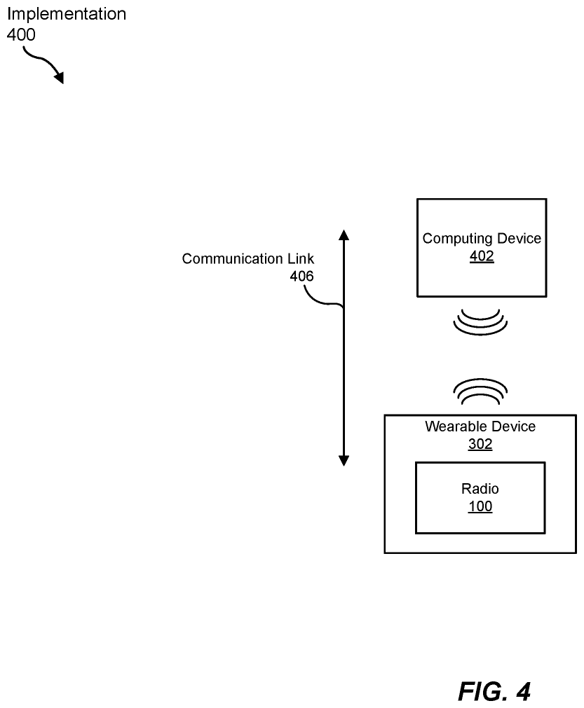

FIG. 4 illustrates a portion of an exemplary implementation 400 involving wearable device 302 equipped with radio 100 in communication with a computing device 402. In some examples, implementation 400 may include and/or represent certain components and/or features that perform and/or provide functionalities that are similar and/or identical to those described above in connection with any of FIGS. 1-3. As illustrated in FIG. 4, wearable device 302 and computing device 402 may establish and/or form a communication link 406 with one another.

In a specific example, controller 102 may select tuner code “RF4” from table 220 based at least in part on telemetry data 204. In one example, the “RF4” tuner code may correspond to and/or represent the “B13” frequency band. In this example, controller 102 may cause and/or direct tuner 104 to apply the “RF4” tuner code to tune radio 100 to the “B13” frequency band. The “RF4” tuner code may enable and/or cause radio 100 to improve performance (e.g., increasing gain and/or decibel levels) of communication link 406 between wearable device 302 and computing device 402.

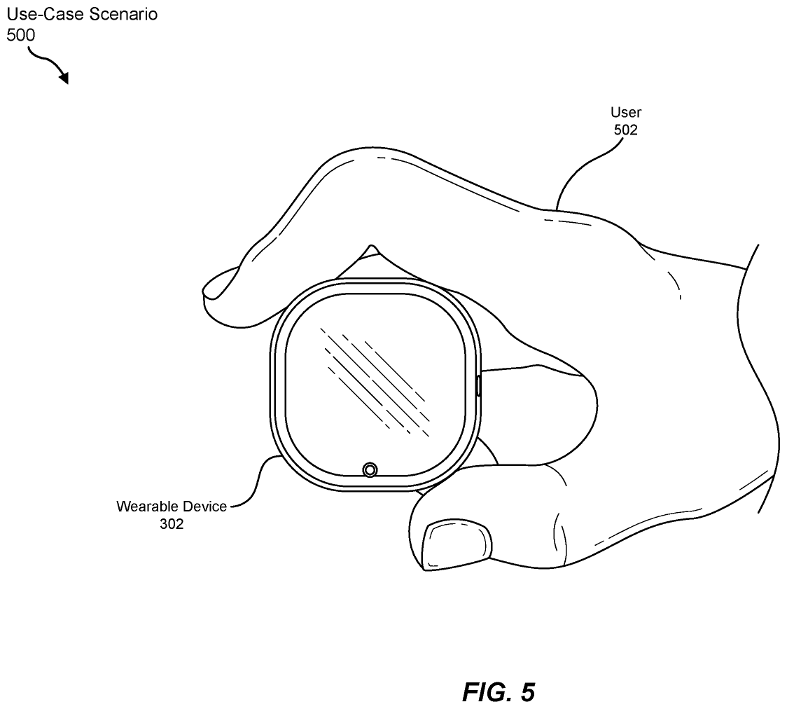

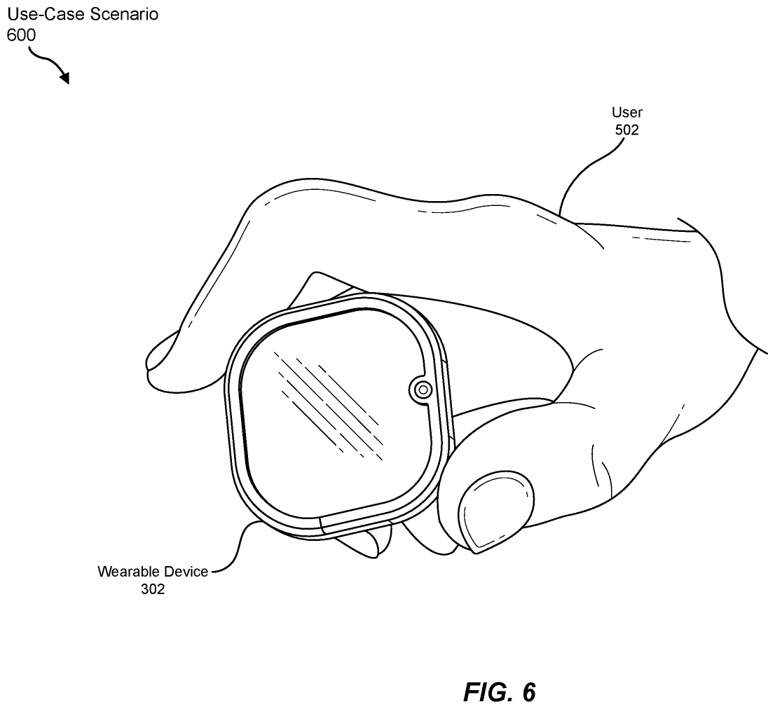

FIGS. 5 and 6 illustrates exemplary use-case scenarios 500 and 600, respectively, of wearable device 302. In some examples, use-case scenarios 500 and 600 may include and/or represent certain components and/or features that perform and/or provide functionalities that are similar and/or identical to those described above in connection with any of FIGS. 1-4. As illustrated in FIG. 5, use-case scenario 500 may involve a user 502 holding wearable device 302 (e.g., a smartwatch removed from its cradle) with the user's index finger placed at the top-left rounded corner and the user's thumb placed at the bottom-right rounded corner.

In some examples, controller 102 may collect sensor data 206 from sensors 210(1)-(N) during use-case scenario 500. In one example, controller 102 may analyze sensor data 206 and then determine, based at least in part on this analysis, that sensor data 206 indicates that wearable device 302 is operating in use-case scenario 500. In this example, controller 102 may search table 220 for the tuner code that is best suited for use-case scenario 500 based at least in part on sensor data 206. For example, during the search, controller 102 may identify tuner code “RF3” as being the best suited for use-case scenario 500. Controller 102 may then cause and/or direct tuner 104 to apply the “RF3” tuner code to tune radio 100 to the “B12” frequency band, thereby potentially achieving better performance for use-case scenario 500.

In some examples, controller 102 may sweep across a subset of candidate tuner codes that are identified in table 220 based at least in part on telemetry data 204 collected during use-case scenario 500. To perform such a sweep, controller 102 may temporarily apply each of the candidate tuner codes to tuner 104 to test different radio states in use-case scenario 500. In this example, modem 208 and/or controller 102 may measure certain key performance indicators (e.g., RSRP, RSRQ, RSSI, and/or SNR) of radio 100 and/or tuner 104 during the sweep across the subset of candidate tuner codes in use-case scenario 500. Controller 102 may then identify the tuner code that results in the best performance among the subset of candidate tuner codes based at least in part on the key performance indicators. Controller 102 may then cause and/or direct tuner 104 to tune radio 100 with that tuner code in the subset to improve performance in use-case scenario 500.

As illustrated in FIG. 6, use-case scenario 600 may involve a user 502 holding wearable device 302 (e.g., a smartwatch removed from its cradle) with the user's index finger placed at the top-right rounded corner and the user's thumb placed at the bottom-left rounded corner. In some examples, controller 102 may collect sensor data 206 from sensors 210(1)-(N) during use-case scenario 600. In one example, controller 102 may analyze sensor data 206 and then determine, based at least in part on this analysis, that sensor data 206 indicates that wearable device 302 is operating in use-case scenario 600. In this example, controller 102 may search table 220 for the tuner code that is best suited for use-case scenario 600 based at least in part on sensor data 206. For example, during the search, controller 102 may identify tuner code “RF2” as being the best suited for use-case scenario 500. Controller 102 may then cause and/or direct tuner 104 to apply the “RF2” tuner code to tune radio 100 to the “B5” frequency band, thereby potentially achieving better performance for use-case scenario 600.

In some examples, controller 102 may sweep across a subset of candidate tuner codes that are identified in table 220 based at least in part on telemetry data 204 collected during use-case scenario 600. To perform such a sweep, controller 102 may temporarily apply each of the candidate tuner codes to tuner 104 to test different radio states in use-case scenario 600. In this example, modem 208 and/or controller 102 may measure certain key performance indicators (e.g., RSRP, RSRQ, RSSI, and/or SNR) of radio 100 and/or tuner 104 during the sweep across the subset of candidate tuner codes in use-case scenario 600. Controller 102 may then identify the tuner code that results in the best performance among the subset of candidate tuner codes based at least in part on the key performance indicators. Controller 102 may then cause and/or direct tuner 104 to tune radio 100 with that tuner code in the subset to improve performance in use-case scenario 600.

In some examples, the various devices and/or systems described in connection with FIGS. 1-6 may include and/or represent one or more additional circuits, components, and/or features that are not necessarily illustrated and/or labeled in FIGS. 1-6. For example, radio 100 and/or wearable device 302 may also include and/or represent additional analog and/or digital circuitry, onboard logic, transistors, resistors, capacitors, diodes, inductors, switches, registers, flipflops, connections, traces, buses, semiconductor (e.g., silicon) devices and/or structures, processing devices, storage devices, circuit boards, packages, substrates, housings, combinations or variations of one or more of the same, and/or any other suitable components that facilitate and/or support dynamic tuning based on detectable use-case scenarios. In certain implementations, one or more of these additional circuits, components, devices, and/or features may be inserted and/or applied between any of the existing circuits, components, and/or devices illustrated in FIGS. 1-6 consistent with the aims and/or objectives provided herein. Accordingly, the electrical and/or communicative couplings described with reference to FIGS. 1-6 may be direct connections with no intermediate components, devices, and/or nodes or indirect connections with one or more intermediate components, devices, and/or nodes.

In some examples, the phrase “to couple” and/or the term “coupling”, as used herein, may refer to a direct connection and/or an indirect connection. For example, a direct coupling between two components may constitute and/or represent a coupling in which those two components are directly connected to each other by a single node that provides electrical continuity from one of those two components to the other. In other words, the direct coupling may exclude and/or omit any additional components between those two components.

Additionally or alternatively, an indirect coupling between two components may constitute and/or represent a coupling in which those two components are indirectly connected to each other by multiple nodes that fail to provide electrical continuity from one of those two components to the other. In other words, the indirect coupling may include and/or incorporate at least one additional component between those two components.

FIG. 7 is a flow diagram of an exemplary method 700 for dynamically tuning radios based on detectable use-case scenarios. In one example, the steps shown in FIG. 7 may be performed during the manufacture and/or assembly of a radio and/or a wearable device. Additionally or alternatively, the steps shown in FIG. 7 may incorporate and/or involve various sub-steps and/or variations consistent with one or more of the descriptions provided above in connection with FIGS. 1-6.

As illustrated in FIG. 7, method 700 may include and/or involve the step of installing a tuner that tunes a radio in a wearable device (710). Step 710 may be performed in a variety of ways, including any of those described above in connection with FIGS. 1-6. For example, a wearable equipment manufacturer may install a tuner that tunes a radio in a wearable device.

In some examples, method 700 may also include and/or involve the step of coupling a controller to the tuner (720). Step 720 may be performed in a variety of ways, including any of those described above in connection with FIGS. 1-6. For example, the wearable equipment manufacturer may couple the controller to the tuner. In one example, the wearable equipment manufacturer may install a modem or one or more additional components between the controller and the tuner.

In some examples, method 700 may also include and/or involve the step of configuring the controller to (1) select a tuner code based at least in part on telemetry data indicative of a certain use-case scenario and (2) cause the tuner to tune the radio by applying the tuner code to achieve a certain state of the radio (730). Step 730 may be performed in a variety of ways, including any of those described above in connection with FIGS. 1-6. For example, the wearable equipment manufacturer may configure the controller to (1) select a tuner code based at least in part on telemetry data indicative of a certain use-case scenario and (2) cause the tuner to tune the radio by applying the tuner code to achieve a certain state of the radio.

### Example Embodiments

Example 1: A system comprising (1) a tuner configured to tune a radio and (2) a controller communicatively coupled to the tuner, wherein the controller is configured to (1) select a tuner code to apply to the tuner based at least in part on telemetry data indicative of a certain use-case scenario and (2) cause the tuner to tune the radio by applying the tuner code to achieve a certain state of the radio.

Example 2: The system of Example 1, further comprising a modem communicatively coupled between the controller and the tuner, wherein (1) the modem is configured to provide one or more measurements about a communication link involving the radio to the controller and (2) the telemetry data comprises the measurements about the communication link.

Example 3: The system of Example 1 or 2, wherein the controller directs the modem to apply the tuner code to achieve the certain state of the radio.

Example 4: The system of any of Examples 1-3, wherein the measurements comprise at least one of (1) a Reference Signal Received Power (RSRP) measurement of the communication link, (2) a Reference Signal Received Quality (RSRQ) measurement of the communication link, (3) a Received Signal Strength Indicator (RSSI) measurement of the communication link, or (4) a Signal-to-Noise Ratio (SNR) of the communication link.

Example 5: The system of any of Examples 1-4, further comprising (1) a wearable device that incorporates the tuner and the controller and (2) one or more sensors that are incorporated in the wearable device and communicatively coupled to the controller, wherein the sensors are configured to (1) generate sensor data about a state of the wearable device and (2) provide the sensor data to the controller. The telemetry data comprises the sensor data.

Example 6: The system of any of Examples 1-5, wherein the sensors comprise at least one of (1) a touch sensor, (2) a vibration sensor, (3) a pressure sensor, (4) an accelerometer, (5) a gyroscope, or (6) a transducer.

Example 7: The system of any of Examples 1-6, further comprising a storage device configured to store a table of tuner codes mapped to indexing data, and wherein the controller is configured to (1) search the table of tuner codes for any tuner code that corresponds to the certain use-case scenario and (2), during the search, identify the tuner code as corresponding to the certain use-case scenario by matching the telemetry data to the indexing data of the tuner code.

Example 8: The system of any of Examples 1-7, wherein the controller is configured to (1) identify a subset of the tuner codes stored in the table based at least in part on the telemetry data, the subset of tuner codes comprising the tuner code, (2) sweep across the subset of the tuner codes to test different states of the radio when the subset of tuner codes are applied, (3) measure one or more performance indicators of the tuner during the sweep across the subset of tuner codes, and (4) determine that the tuner code is an optimal selection for the tuner based at least in part on the performance indicators.

Example 9: The system of any of Examples 1-8, wherein the controller is configured to update the table to prioritize one of the tuner codes over another one of the tuner codes for the certain use-case scenario based at least in part on a previous performance of the one of the tuner codes.

Example 10: The system of any of Examples 1-9, wherein the controller is configured to select the tuner code without considering a Voltage Standing Wave Ratio (VSWR) of the radio or relying on a VSWR detector.

Example 11: The system of any of Examples 1-10, wherein the controller is configured to (1) identify the certain use-case scenario based at least in part on the telemetry data, (2) identify a frequency band of the radio that corresponds to the certain use-case scenario, and (3) select the tuner code to apply to the tuner based at least in part on the frequency band that corresponds to the certain use-case scenario.

Example 12: The system of any of Examples 1-11, wherein the controller is configured to (1) identify a model of at least one component of the radio and (2) select the tuner code to apply to the tuner based at least in part on the model of the component of the radio.

Example 13: The system of any of Examples 1-12, wherein the controller is configured to (1) detect an event that triggers a modification to the tuner and (2) select the tuner code to apply to the tuner in response to detecting the event.

Example 14: The system of any of Examples 1-13, further comprising a wearable device that incorporates the tuner and the controller, and wherein the event comprises a position change of the wearable device.

Example 15: The system of any of Examples 1-14, further comprising a wearable device that (1) incorporates the tuner and the controller and (2) is dimensioned to be donned by a user, and wherein the certain use-case scenario comprises at least one of (1) the user dons the wearable device on a wrist, (2) the user holds the wearable device with one or more fingers, (3) the user performs a certain gesture while donning the wearable device, (4) the wearable device is operating in free space, or (5) the wearable device is operating with a certain accessory.

Example 16: A wearable device comprising (1) a tuner configured to tune a radio and (2) a controller communicatively coupled to the tuner, wherein the controller is configured to (1) select a tuner code to apply to the tuner based at least in part on telemetry data indicative of a certain use-case scenario and (2) causes the tuner to tune the radio by applying the tuner code to achieve a certain state of the radio.

Example 17: The wearable device of claim 16, further comprising a modem communicatively coupled between the controller and the tuner, wherein (1) the modem is configured to provide one or more measurements about a communication link involving the radio to the controller and (2) the telemetry data comprises the measurements about the communication link.

Example 18: The wearable device of claim 17, wherein the controller directs the modem the modem to apply the tuner code to achieve the certain state of the radio.

Example 19: The wearable device of claim 17, wherein the measurements comprise at least one of (1) a Reference Signal Received Power (RSRP) measurement of the communication link, (2) a Reference Signal Received Quality (RSRQ) measurement of the communication link, (3) a Received Signal Strength Indicator (RSSI) measurement of the communication link, or (4) a Signal-to-Noise Ratio (SNR) of the communication link.

Example 20: A method comprising (1) installing a tuner that tunes a radio in a wearable device, (2) coupling a controller to the tuner, and (3) configuring the controller to (A) select a tuner code to apply to the tuner based at least in part on telemetry data indicative of a certain use-case scenario and (B) cause the tuner to tune the radio by applying the tuner code to achieve a certain state of the radio.

Embodiments of the present disclosure may include or be implemented in conjunction with various types of artificial-reality systems. Artificial reality is a form of reality that has been adjusted in some manner before presentation to a user, which may include, for example, a virtual reality, an augmented reality, a mixed reality, a hybrid reality, or some combination and/or derivative thereof. Artificial-reality content may include completely computer-generated content or computer-generated content combined with captured (e.g., real-world) content. The artificial-reality content may include video, audio, haptic feedback, or some combination thereof, any of which may be presented in a single channel or in multiple channels (such as stereo video that produces a three-dimensional (3D) effect to the viewer). Additionally, in some embodiments, artificial reality may also be associated with applications, products, accessories, services, or some combination thereof, that are used to, for example, create content in an artificial reality and/or are otherwise used in (e.g., to perform activities in) an artificial reality.

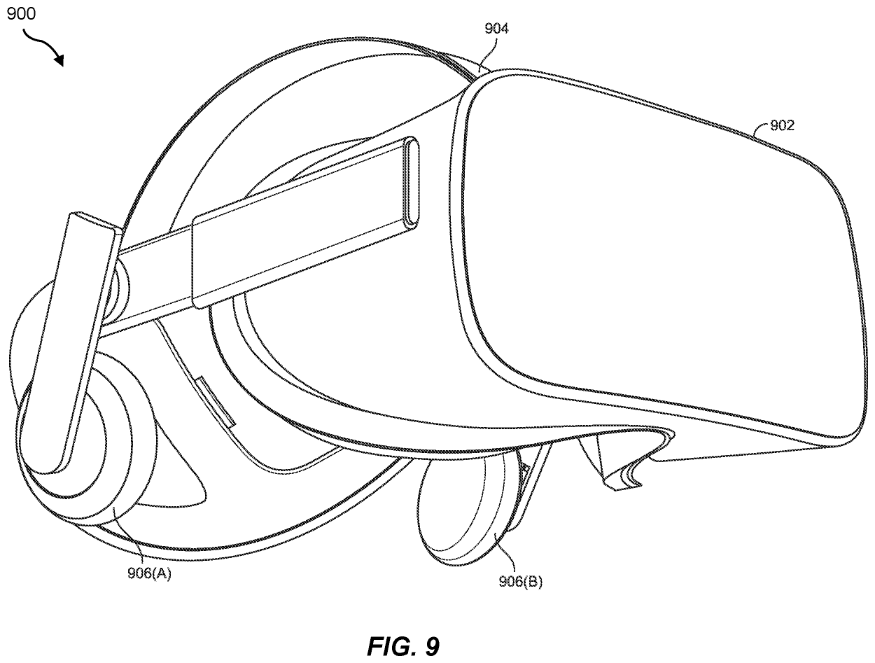

Artificial-reality systems may be implemented in a variety of different form factors and configurations. Some artificial-reality systems may be designed to work without near-eye displays (NEDs). Other artificial-reality systems may include an NED that also provides visibility into the real world (such as, e.g., augmented-reality system 800 in FIG. 8) or that visually immerses a user in an artificial reality (such as, e.g., virtual-reality system 900 in FIG. 9). While some artificial-reality devices may be self-contained systems, other artificial-reality devices may communicate and/or coordinate with external devices to provide an artificial-reality experience to a user. Examples of such external devices include handheld controllers, mobile devices, desktop computers, devices worn by a user, devices worn by one or more other users, and/or any other suitable external system.

Turning to FIG. 8, augmented-reality system 800 may include an eyewear device 802 with a frame 810 configured to hold a left display device 815(A) and a right display device 815(B) in front of a user's eyes. Display devices 815(A) and 815(B) may act together or independently to present an image or series of images to a user. While augmented-reality system 800 includes two displays, embodiments of this disclosure may be implemented in augmented-reality systems with a single NED or more than two NEDs.

In some embodiments, augmented-reality system 800 may include one or more sensors, such as sensor 840. Sensor 840 may generate measurement signals in response to motion of augmented-reality system 800 and may be located on substantially any portion of frame 810. Sensor 840 may represent one or more of a variety of different sensing mechanisms, such as a position sensor, an inertial measurement unit (IMU), a depth camera assembly, a structured light emitter and/or detector, or any combination thereof. In some embodiments, augmented-reality system 800 may or may not include sensor 840 or may include more than one sensor. In embodiments in which sensor 840 includes an IMU, the IMU may generate calibration data based on measurement signals from sensor 840. Examples of sensor 840 may include, without limitation, accelerometers, gyroscopes, magnetometers, other suitable types of sensors that detect motion, sensors used for error correction of the IMU, or some combination thereof.

In some examples, augmented-reality system 800 may also include a microphone array with a plurality of acoustic transducers 820(A)-820(J), referred to collectively as acoustic transducers 820. Acoustic transducers 820 may represent transducers that detect air pressure variations induced by sound waves. Each acoustic transducer 820 may be configured to detect sound and convert the detected sound into an electronic format (e.g., an analog or digital format). The microphone array in FIG. 8 may include, for example, ten acoustic transducers: 820(A) and 820(B), which may be designed to be placed inside a corresponding ear of the user, acoustic transducers 820(C), 820(D), 820(E), 820(F), 820(G), and 820(H), which may be positioned at various locations on frame 810, and/or acoustic transducers 820(I) and 820(J), which may be positioned on a corresponding neckband 805.

In some embodiments, one or more of acoustic transducers 820(A)-(J) may be used as output transducers (e.g., speakers). For example, acoustic transducers 820(A) and/or 820(B) may be earbuds or any other suitable type of headphone or speaker.

The configuration of acoustic transducers 820 of the microphone array may vary. While augmented-reality system 800 is shown in FIG. 8 as having ten acoustic transducers 820, the number of acoustic transducers 820 may be greater or less than ten. In some embodiments, using higher numbers of acoustic transducers 820 may increase the amount of audio information collected and/or the sensitivity and accuracy of the audio information. In contrast, using a lower number of acoustic transducers 820 may decrease the computing power required by an associated controller 850 to process the collected audio information. In addition, the position of each acoustic transducer 820 of the microphone array may vary. For example, the position of an acoustic transducer 820 may include a defined position on the user, a defined coordinate on frame 810, an orientation associated with each acoustic transducer 820, or some combination thereof.

Acoustic transducers 820(A) and 820(B) may be positioned on different parts of the user's ear, such as behind the pinna, behind the tragus, and/or within the auricle or fossa. Or, there may be additional acoustic transducers 820 on or surrounding the ear in addition to acoustic transducers 820 inside the ear canal. Having an acoustic transducer 820 positioned next to an ear canal of a user may enable the microphone array to collect information on how sounds arrive at the ear canal. By positioning at least two of acoustic transducers 820 on either side of a user's head (e.g., as binaural microphones), augmented-reality system 800 may simulate binaural hearing and capture a 3D stereo sound field around about a user's head. In some embodiments, acoustic transducers 820(A) and 820(B) may be connected to augmented-reality system 800 via a wired connection 830, and in other embodiments acoustic transducers 820(A) and 820(B) may be connected to augmented-reality system 800 via a wireless connection (e.g., a BLUETOOTH connection). In still other embodiments, acoustic transducers 820(A) and 820(B) may not be used at all in conjunction with augmented-reality system 800.

Acoustic transducers 820 on frame 810 may be positioned in a variety of different ways, including along the length of the temples, across the bridge, above or below display devices 815(A) and 815(B), or some combination thereof. Acoustic transducers 820 may also be oriented such that the microphone array is able to detect sounds in a wide range of directions surrounding the user wearing the augmented-reality system 800. In some embodiments, an optimization process may be performed during manufacturing of augmented-reality system 800 to determine relative positioning of each acoustic transducer 820 in the microphone array.

In some examples, augmented-reality system 800 may include or be connected to an external device (e.g., a paired device), such as neckband 805. Neckband 805 generally represents any type or form of paired device. Thus, the following discussion of neckband 805 may also apply to various other paired devices, such as charging cases, smart watches, smart phones, wrist bands, other wearable devices, hand-held controllers, tablet computers, laptop computers, other external compute devices, etc.

As shown, neckband 805 may be coupled to eyewear device 802 via one or more connectors. The connectors may be wired or wireless and may include electrical and/or non-electrical (e.g., structural) components. In some cases, eyewear device 802 and neckband 805 may operate independently without any wired or wireless connection between them. While FIG. 8 illustrates the components of eyewear device 802 and neckband 805 in example locations on eyewear device 802 and neckband 805, the components may be located elsewhere and/or distributed differently on eyewear device 802 and/or neckband 805. In some embodiments, the components of eyewear device 802 and neckband 805 may be located on one or more additional peripheral devices paired with eyewear device 802, neckband 805, or some combination thereof.

Pairing external devices, such as neckband 805, with augmented-reality eyewear devices may enable the eyewear devices to achieve the form factor of a pair of glasses while still providing sufficient battery and computation power for expanded capabilities. Some or all of the battery power, computational resources, and/or additional features of augmented-reality system 800 may be provided by a paired device or shared between a paired device and an eyewear device, thus reducing the weight, heat profile, and form factor of the eyewear device overall while still retaining desired functionality. For example, neckband 805 may allow components that would otherwise be included on an eyewear device to be included in neckband 805 since users may tolerate a heavier weight load on their shoulders than they would tolerate on their heads. Neckband 805 may also have a larger surface area over which to diffuse and disperse heat to the ambient environment. Thus, neckband 805 may allow for greater battery and computation capacity than might otherwise have been possible on a stand-alone eyewear device. Since weight carried in neckband 805 may be less invasive to a user than weight carried in eyewear device 802, a user may tolerate wearing a lighter eyewear device and carrying or wearing the paired device for greater lengths of time than a user would tolerate wearing a heavy standalone eyewear device, thereby enabling users to more fully incorporate artificial-reality environments into their day-to-day activities.

Neckband 805 may be communicatively coupled with eyewear device 802 and/or to other devices. These other devices may provide certain functions (e.g., tracking, localizing, depth mapping, processing, storage, etc.) to augmented-reality system 800. In the embodiment of FIG. 8, neckband 805 may include two acoustic transducers (e.g., 820(l) and 820(J)) that are part of the microphone array (or potentially form their own microphone subarray). Neckband 805 may also include a controller 825 and a power source 835.

Acoustic transducers 820(I) and 820(J) of neckband 805 may be configured to detect sound and convert the detected sound into an electronic format (analog or digital). In the embodiment of FIG. 8, acoustic transducers 820(I) and 820(J) may be positioned on neckband 805, thereby increasing the distance between the neckband acoustic transducers 820(l) and 820(J) and other acoustic transducers 820 positioned on eyewear device 802. In some cases, increasing the distance between acoustic transducers 820 of the microphone array may improve the accuracy of beamforming performed via the microphone array. For example, if a sound is detected by acoustic transducers 820(C) and 820(D) and the distance between acoustic transducers 820(C) and 820(D) is greater than, e.g., the distance between acoustic transducers 820(D) and 820(E), the determined source location of the detected sound may be more accurate than if the sound had been detected by acoustic transducers 820(D) and 820(E).

Controller 825 of neckband 805 may process information generated by the sensors on neckband 805 and/or augmented-reality system 800. For example, controller 825 may process information from the microphone array that describes sounds detected by the microphone array. For each detected sound, controller 825 may perform a direction-of-arrival (DOA) estimation to estimate a direction from which the detected sound arrived at the microphone array. As the microphone array detects sounds, controller 825 may populate an audio data set with the information. In embodiments in which augmented-reality system 800 includes an inertial measurement unit, controller 825 may compute all inertial and spatial calculations from the IMU located on eyewear device 802. A connector may convey information between augmented-reality system 800 and neckband 805 and between augmented-reality system 800 and controller 825. The information may be in the form of optical data, electrical data, wireless data, or any other transmittable data form. Moving the processing of information generated by augmented-reality system 800 to neckband 805 may reduce weight and heat in eyewear device 802, making it more comfortable to the user.

Power source 835 in neckband 805 may provide power to eyewear device 802 and/or to neckband 805. Power source 835 may include, without limitation, lithium ion batteries, lithium-polymer batteries, primary lithium batteries, alkaline batteries, or any other form of power storage. In some cases, power source 835 may be a wired power source. Including power source 835 on neckband 805 instead of on eyewear device 802 may help better distribute the weight and heat generated by power source 835.

As noted, some artificial-reality systems may, instead of blending an artificial reality with actual reality, substantially replace one or more of a user's sensory perceptions of the real world with a virtual experience. One example of this type of system is a head-worn display system, such as virtual-reality system 900 in FIG. 9, that mostly or completely covers a user's field of view. Virtual-reality system 900 may include a front rigid body 902 and a band 904 shaped to fit around a user's head. Virtual-reality system 900 may also include output audio transducers 906(A) and 906(B). Furthermore, while not shown in FIG. 9, front rigid body 902 may include one or more electronic elements, including one or more electronic displays, one or more inertial measurement units (IMUs), one or more tracking emitters or detectors, and/or any other suitable device or system for creating an artificial-reality experience.

Artificial-reality systems may include a variety of types of visual feedback mechanisms. For example, display devices in augmented-reality system 800 and/or virtual-reality system 900 may include one or more liquid crystal displays (LCDs), light emitting diode (LED) displays, microLED displays, organic LED (OLED) displays, digital light project (DLP) micro-displays, liquid crystal on silicon (LCoS) micro-displays, and/or any other suitable type of display screen. These artificial-reality systems may include a single display screen for both eyes or may provide a display screen for each eye, which may allow for additional flexibility for varifocal adjustments or for correcting a user's refractive error. Some of these artificial-reality systems may also include optical subsystems having one or more lenses (e.g., concave or convex lenses, Fresnel lenses, adjustable liquid lenses, etc.) through which a user may view a display screen. These optical subsystems may serve a variety of purposes, including to collimate (e.g., make an object appear at a greater distance than its physical distance), to magnify (e.g., make an object appear larger than its actual size), and/or to relay (to, e.g., the viewer's eyes) light. These optical subsystems may be used in a non-pupil-forming architecture (such as a single lens configuration that directly collimates light but results in so-called pincushion distortion) and/or a pupil-forming architecture (such as a multi-lens configuration that produces so-called barrel distortion to nullify pincushion distortion).

In addition to or instead of using display screens, some of the artificial-reality systems described herein may include one or more projection systems. For example, display devices in augmented-reality system 800 and/or virtual-reality system 900 may include microLED projectors that project light (using, e.g., a waveguide) into display devices, such as clear combiner lenses that allow ambient light to pass through. The display devices may refract the projected light toward a user's pupil and may enable a user to simultaneously view both artificial-reality content and the real world. The display devices may accomplish this using any of a variety of different optical components, including waveguide components (e.g., holographic, planar, diffractive, polarized, and/or reflective waveguide elements), light-manipulation surfaces and elements (such as diffractive, reflective, and refractive elements and gratings), coupling elements, etc. Artificial-reality systems may also be configured with any other suitable type or form of image projection system, such as retinal projectors used in virtual retina displays.

The artificial-reality systems described herein may also include various types of computer vision components and subsystems. For example, augmented-reality system 800 and/or virtual-reality system 900 may include one or more optical sensors, such as two-dimensional (2D) or 3D cameras, structured light transmitters and detectors, time-of-flight depth sensors, single-beam or sweeping laser rangefinders, 3D LiDAR sensors, and/or any other suitable type or form of optical sensor. An artificial-reality system may process data from one or more of these sensors to identify a location of a user, to map the real world, to provide a user with context about real-world surroundings, and/or to perform a variety of other functions.

The artificial-reality systems described herein may also include one or more input and/or output audio transducers. Output audio transducers may include voice coil speakers, ribbon speakers, electrostatic speakers, piezoelectric speakers, bone conduction transducers, cartilage conduction transducers, tragus-vibration transducers, and/or any other suitable type or form of audio transducer. Similarly, input audio transducers may include condenser microphones, dynamic microphones, ribbon microphones, and/or any other type or form of input transducer. In some embodiments, a single transducer may be used for both audio input and audio output.

In some embodiments, the artificial-reality systems described herein may also include tactile (i.e., haptic) feedback systems, which may be incorporated into headwear, gloves, body suits, handheld controllers, environmental devices (e.g., chairs, floormats, etc.), and/or any other type of device or system. Haptic feedback systems may provide various types of cutaneous feedback, including vibration, force, traction, texture, and/or temperature. Haptic feedback systems may also provide various types of kinesthetic feedback, such as motion and compliance. Haptic feedback may be implemented using motors, piezoelectric actuators, fluidic systems, and/or a variety of other types of feedback mechanisms. Haptic feedback systems may be implemented independent of other artificial-reality devices, within other artificial-reality devices, and/or in conjunction with other artificial-reality devices.

By providing haptic sensations, audible content, and/or visual content, artificial-reality systems may create an entire virtual experience or enhance a user's real-world experience in a variety of contexts and environments. For instance, artificial-reality systems may assist or extend a user's perception, memory, or cognition within a particular environment. Some systems may enhance a user's interactions with other people in the real world or may enable more immersive interactions with other people in a virtual world. Artificial-reality systems may also be used for educational purposes (e.g., for teaching or training in schools, hospitals, government organizations, military organizations, business enterprises, etc.), entertainment purposes (e.g., for playing video games, listening to music, watching video content, etc.), and/or for accessibility purposes (e.g., as hearing aids, visual aids, etc.). The embodiments disclosed herein may enable or enhance a user's artificial-reality experience in one or more of these contexts and environments and/or in other contexts and environments.

As noted, artificial-reality systems 800 and 900 may be used with a variety of other types of devices to provide a more compelling artificial-reality experience. These devices may be haptic interfaces with transducers that provide haptic feedback and/or that collect haptic information about a user's interaction with an environment. The artificial-reality systems disclosed herein may include various types of haptic interfaces that detect or convey various types of haptic information, including tactile feedback (e.g., feedback that a user detects via nerves in the skin, which may also be referred to as cutaneous feedback) and/or kinesthetic feedback (e.g., feedback that a user detects via receptors located in muscles, joints, and/or tendons).

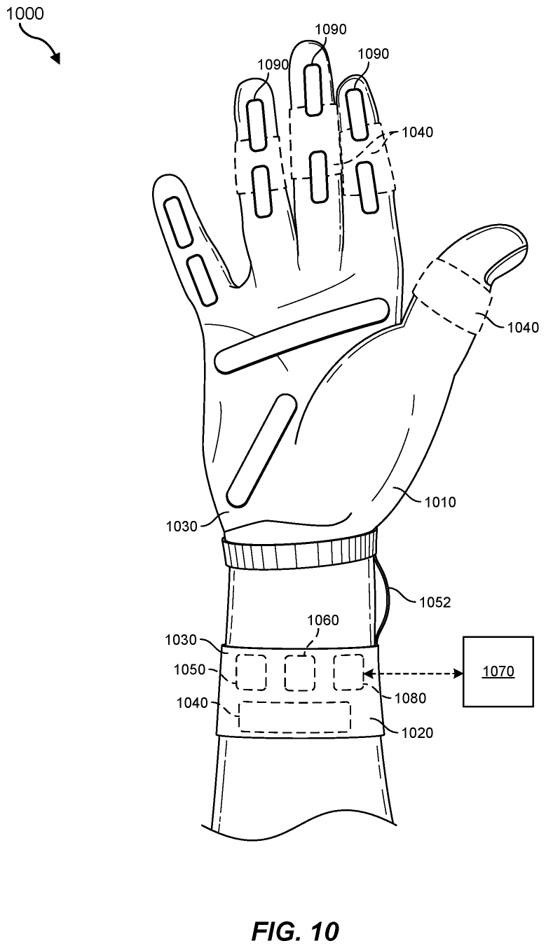

Haptic feedback may be provided by interfaces positioned within a user's environment (e.g., chairs, tables, floors, etc.) and/or interfaces on articles that may be worn or carried by a user (e.g., gloves, wristbands, etc.). As an example, FIG. 10 illustrates a vibrotactile system 1000 in the form of a wearable glove (haptic device 1010) and wristband (haptic device 1020). Haptic device 1010 and haptic device 1020 are shown as examples of wearable devices that include a flexible, wearable textile material 1030 that is shaped and configured for positioning against a user's hand and wrist, respectively. This disclosure also includes vibrotactile systems that may be shaped and configured for positioning against other human body parts, such as a finger, an arm, a head, a torso, a foot, or a leg. By way of example and not limitation, vibrotactile systems according to various embodiments of the present disclosure may also be in the form of a glove, a headband, an armband, a sleeve, a head covering, a sock, a shirt, or pants, among other possibilities. In some examples, the term “textile” may include any flexible, wearable material, including woven fabric, non-woven fabric, leather, cloth, a flexible polymer material, composite materials, etc.

One or more vibrotactile devices 1040 may be positioned at least partially within one or more corresponding pockets formed in textile material 1030 of vibrotactile system 1000. Vibrotactile devices 1040 may be positioned in locations to provide a vibrating sensation (e.g., haptic feedback) to a user of vibrotactile system 1000. For example, vibrotactile devices 1040 may be positioned against the user's finger(s), thumb, or wrist, as shown in FIG. 10. Vibrotactile devices 1040 may, in some examples, be sufficiently flexible to conform to or bend with the user's corresponding body part(s).

A power source 1050 (e.g., a battery) for applying a voltage to the vibrotactile devices 1040 for activation thereof may be electrically coupled to vibrotactile devices 1040, such as via conductive wiring 1052. In some examples, each of vibrotactile devices 1040 may be independently electrically coupled to power source 1050 for individual activation. In some embodiments, a processor 1060 may be operatively coupled to power source 1050 and configured (e.g., programmed) to control activation of vibrotactile devices 1040.

Vibrotactile system 1000 may be implemented in a variety of ways. In some examples, vibrotactile system 1000 may be a standalone system with integral subsystems and components for operation independent of other devices and systems. As another example, vibrotactile system 1000 may be configured for interaction with another device or system 1070. For example, vibrotactile system 1000 may, in some examples, include a communications interface 1080 for receiving and/or sending signals to the other device or system 1070. The other device or system 1070 may be a mobile device, a gaming console, an artificial-reality (e.g., virtual-reality, augmented-reality, mixed-reality) device, a personal computer, a tablet computer, a network device (e.g., a modem, a router, etc.), a handheld controller, etc. Communications interface 1080 may enable communications between vibrotactile system 1000 and the other device or system 1070 via a wireless (e.g., Wi-Fi, BLUETOOTH, cellular, radio, etc.) link or a wired link. If present, communications interface 1080 may be in communication with processor 1060, such as to provide a signal to processor 1060 to activate or deactivate one or more of the vibrotactile devices 1040.

Vibrotactile system 1000 may optionally include other subsystems and components, such as touch-sensitive pads 1090, pressure sensors, motion sensors, position sensors, lighting elements, and/or user interface elements (e.g., an on/off button, a vibration control element, etc.). During use, vibrotactile devices 1040 may be configured to be activated for a variety of different reasons, such as in response to the user's interaction with user interface elements, a signal from the motion or position sensors, a signal from the touch-sensitive pads 1090, a signal from the pressure sensors, a signal from the other device or system 1070, etc.

Although power source 1050, processor 1060, and communications interface 1080 are illustrated in FIG. 10 as being positioned in haptic device 1020, the present disclosure is not so limited. For example, one or more of power source 1050, processor 1060, or communications interface 1080 may be positioned within haptic device 1010 or within another wearable textile.

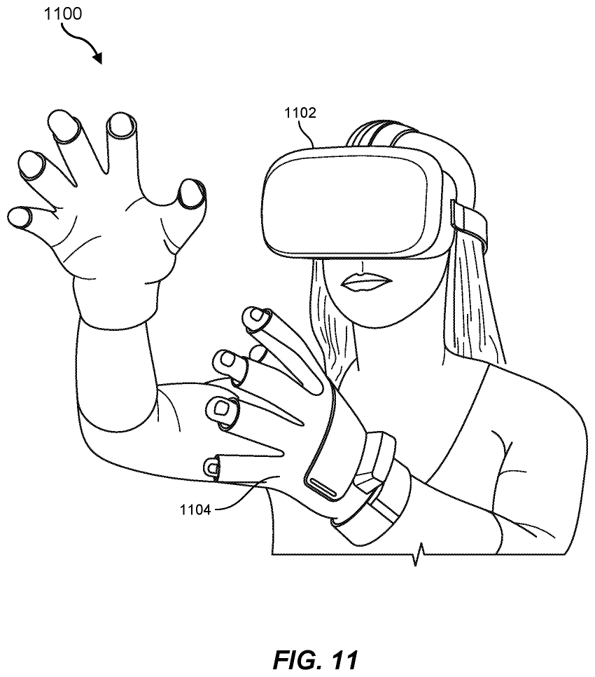

Haptic wearables, such as those shown in and described in connection with FIG. 10, may be implemented in a variety of types of artificial-reality systems and environments. FIG. 11 shows an example artificial-reality environment 1100 including one head-mounted virtual-reality display and two haptic devices (i.e., gloves), and in other embodiments any number and/or combination of these components and other components may be included in an artificial-reality system. For example, in some embodiments there may be multiple head-mounted displays each having an associated haptic device, with each head-mounted display and each haptic device communicating with the same console, portable computing device, or other computing system.

Head-mounted display 1102 generally represents any type or form of virtual-reality system, such as virtual-reality system 900 in FIG. 9. Haptic device 1104 generally represents any type or form of wearable device, worn by a user of an artificial-reality system, that provides haptic feedback to the user to give the user the perception that he or she is physically engaging with a virtual object. In some embodiments, haptic device 1104 may provide haptic feedback by applying vibration, motion, and/or force to the user. For example, haptic device 1104 may limit or augment a user's movement. To give a specific example, haptic device 1104 may limit a user's hand from moving forward so that the user has the perception that his or her hand has come in physical contact with a virtual wall. In this specific example, one or more actuators within the haptic device may achieve the physical-movement restriction by pumping fluid into an inflatable bladder of the haptic device. In some examples, a user may also use haptic device 1104 to send action requests to a console. Examples of action requests include, without limitation, requests to start an application and/or end the application and/or requests to perform a particular action within the application.

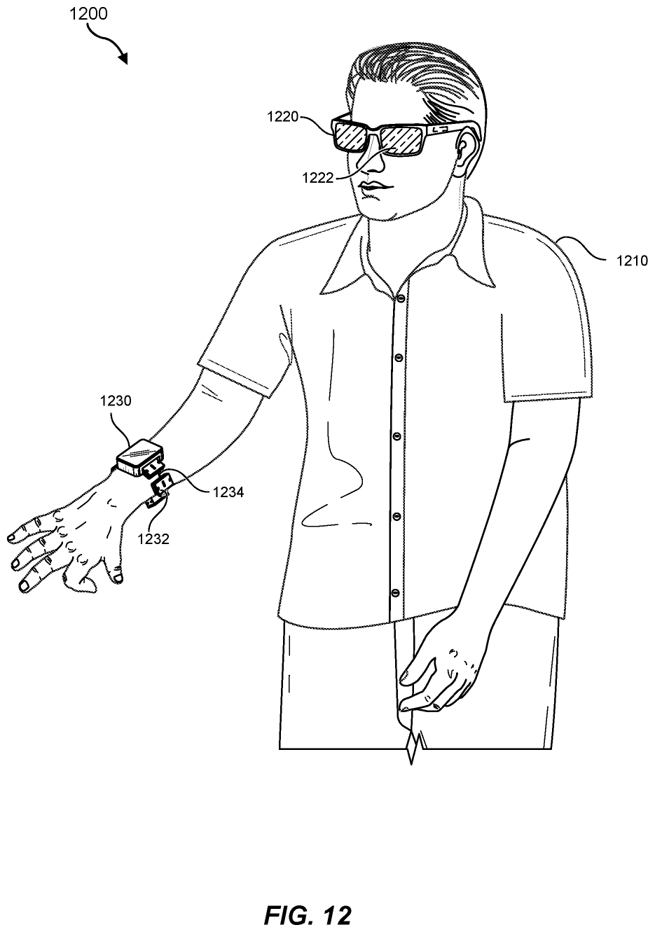

While haptic interfaces may be used with virtual-reality systems, as shown in FIG. 11, haptic interfaces may also be used with augmented-reality systems, as shown in FIG. 12. FIG. 12 is a perspective view of a user 1210 interacting with an augmented-reality system 1200. In this example, user 1210 may wear a pair of augmented-reality glasses 1220 that may have one or more displays 1222 and that are paired with a haptic device 1230. In this example, haptic device 1230 may be a wristband that includes a plurality of band elements 1232 and a tensioning mechanism 1234 that connects band elements 1232 to one another.

One or more of band elements 1232 may include any type or form of actuator suitable for providing haptic feedback. For example, one or more of band elements 1232 may be configured to provide one or more of various types of cutaneous feedback, including vibration, force, traction, texture, and/or temperature. To provide such feedback, band elements 1232 may include one or more of various types of actuators. In one example, each of band elements 1232 may include a vibrotactor (e.g., a vibrotactile actuator) configured to vibrate in unison or independently to provide one or more of various types of haptic sensations to a user. Alternatively, only a single band element or a subset of band elements may include vibrotactors.

Haptic devices 1010, 1020, 1104, and 1230 may include any suitable number and/or type of haptic transducer, sensor, and/or feedback mechanism. For example, haptic devices 1010, 1020, 1104, and 1230 may include one or more mechanical transducers, piezoelectric transducers, and/or fluidic transducers. Haptic devices 1010, 1020, 1104, and 1230 may also include various combinations of different types and forms of transducers that work together or independently to enhance a user's artificial-reality experience. In one example, each of band elements 1232 of haptic device 1230 may include a vibrotactor (e.g., a vibrotactile actuator) configured to vibrate in unison or independently to provide one or more of various types of haptic sensations to a user.

The process parameters and sequence of the steps described and/or illustrated herein are given by way of example only and may be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to any claims appended hereto and their equivalents in determining the scope of the present disclosure.

Unless otherwise noted, the terms “connected to” and “coupled to” (and their derivatives), as used in the specification and/or claims, are to be construed as permitting both direct and indirect (i.e., via other elements or components) connection. In addition, the terms “a” or “an,” as used in the specification and/or claims, are to be construed as meaning “at least one of.” Finally, for ease of use, the terms “including” and “having” (and their derivatives), as used in the specification and/or claims, are interchangeable with and have the same meaning as the word “comprising.”

What is claimed is:

1. A system comprising:
a tuner configured to tune a radio; and
a controller communicatively coupled to the tuner, wherein the controller is configured to:
select a tuner code to apply to the tuner based at least in part on telemetry data indicative of a certain use-case scenario; and
cause the tuner to tune the radio by applying the tuner code to achieve a certain state of the radio.

2. The system of claim 1, further comprising a modem communicatively coupled between the controller and the tuner, wherein:
the modem is configured to provide one or more measurements about a communication link involving the radio to the controller; and
the telemetry data comprises the measurements about the communication link.

3. The system of claim 2, wherein the controller directs the modem to apply the tuner code to achieve the certain state of the radio.

4. The system of claim 2, wherein the measurements comprise at least one of:
a Reference Signal Received Power (RSRP) measurement of the communication link;
a Reference Signal Received Quality (RSRQ) measurement of the communication link;
a Received Signal Strength Indicator (RSSI) measurement of the communication link; or
a Signal-to-Noise Ratio (SNR) of the communication link.

5. The system of claim 1, further comprising:
a wearable device that incorporates the tuner and the controller; and
one or more sensors that are incorporated in the wearable device and communicatively coupled to the controller, wherein:
the sensors are configured to:
generate sensor data about a state of the wearable device; and
provide the sensor data to the controller; and
the telemetry data comprises the sensor data.

6. The system of claim 5, wherein the sensors comprise at least one of:
a touch sensor;
a vibration sensor;
a pressure sensor;
an accelerometer;
a gyroscope; or
a transducer.

7. The system of claim 1, further comprising a storage device configured to store a table of tuner codes mapped to indexing data; and
wherein the controller is configured to:
search the table of tuner codes for any tuner code that corresponds to the certain use-case scenario; and
during the search, identify the tuner code as corresponding to the certain use-case scenario by matching the telemetry data to the indexing data of the tuner code.

8. The system of claim 7, wherein the controller is configured to:
identify a subset of the tuner codes stored in the table based at least in part on the telemetry data, the subset of tuner codes comprising the tuner code;
sweep across the subset of the tuner codes to test different states of the radio when the subset of tuner codes are applied;
measure one or more performance indicators of the tuner during the sweep across the subset of tuner codes; and
determine that the tuner code is an optimal selection for the tuner based at least in part on the performance indicators.

9. The system of claim 7, wherein the controller is configured to update the table to prioritize one of the tuner codes over another one of the tuner codes for the certain use-case scenario based at least in part on a previous performance of the one of the tuner codes.

10. The system of claim 1, wherein the controller is configured to select the tuner code without considering a Voltage Standing Wave Ratio (VSWR) of the radio or relying on a VSWR detector.

11. The system of claim 1, wherein the controller is configured to:
identify the certain use-case scenario based at least in part on the telemetry data;
identify a frequency band of the radio that corresponds to the certain use-case scenario; and
select the tuner code to apply to the tuner based at least in part on the frequency band that corresponds to the certain use-case scenario.

12. The system of claim 1, wherein the controller is configured to:
identify a model of at least one component of the radio; and
select the tuner code to apply to the tuner based at least in part on the model of the component of the radio.

13. The system of claim 1, wherein the controller is configured to:
detect an event that triggers a modification to the tuner; and
select the tuner code to apply to the tuner in response to detecting the event.

14. The system of claim 13, further comprising a wearable device that incorporates the tuner and the controller; and
wherein the event comprises a position change of the wearable device.

15. The system of claim 1, further comprising a wearable device that:
incorporates the tuner and the controller; and
is dimensioned to be donned by a user;
wherein the certain use-case scenario comprises at least one of:
the user dons the wearable device on a wrist;
the user holds the wearable device with one or more fingers;
the user performs a certain gesture while donning the wearable device;
the wearable device is operating in free space; or
the wearable device is operating with a certain accessory.

16. A wearable device comprising:
a tuner configured to tune a radio; and
a controller communicatively coupled to the tuner, wherein the controller is configured to:
select a tuner code to apply to the tuner based at least in part on telemetry data indicative of a certain use-case scenario; and
causes the tuner to tune the radio by applying the tuner code to achieve a certain state of the radio.

17. The wearable device of claim 16, further comprising a modem communicatively coupled between the controller and the tuner, wherein:
the modem is configured to provide one or more measurements about a communication link involving the radio to the controller; and
the telemetry data comprises the measurements about the communication link.

18. The wearable device of claim 17, wherein the controller directs the modem the modem to apply the tuner code to achieve the certain state of the radio.

19. The wearable device of claim 17, wherein the measurements comprise at least one of:
a Reference Signal Received Power (RSRP) measurement of the communication link;
a Reference Signal Received Quality (RSRQ) measurement of the communication link;
a Received Signal Strength Indicator (RSSI) measurement of the communication link; or
a Signal-to-Noise Ratio (SNR) of the communication link.

20. A method comprising:
installing a tuner that tunes a radio in a wearable device;
coupling a controller to the tuner; and
configuring the controller to:
select a tuner code to apply to the tuner based at least in part on telemetry data indicative of a certain use-case scenario; and
cause the tuner to tune the radio by applying the tuner code to achieve a certain state of the radio.
